(19) United States
(12) Patent Application Publication
(10) Pub. No.: US 2016/0170514 A1
(43) Pub. Date: Jun. 16, 2016

(54) TOUCH SCREEN STRUCTURE AND MANUFACTURING METHOD THEREOF

(71) Applicant: HYUNDAI MOTOR COMPANY, Seoul (KR)

(72) Inventors: Sang Soo JEON, Uiwang-si (KR); Tae Seung LEE, Suwon-si (KR)

(21) Appl. No.: 14/703,629

(22) Filed: May 4, 2015

(30) Foreign Application Priority Data
Dec. 12, 2014 (KR) 10-2014-0179070

(51) Int. Cl. G06F 3/041

(52) U.S. Cl. CPC G06F 3/041; G06F 2203/04103

(57) ABSTRACT

The present disclosure relates to a touch screen structure and a manufacturing method thereof. The touch screen structure includes: a touch panel part preventing light from being reflected to an upper surface and a lower surface; and an LCD part positioned at a lower portion, including the touch panel part and an air layer, whereby the high-durability anti reflection coating layer is formed on the anti glare film to improve the scratch resistance, the salt water resistance, the light resistance, and the like so as to reduce the light reflectance of the touch screen and improve the visibility, thereby improving the marketability and convenience and realizing the anti-glaring to safely drive the vehicle.

### CROSS-REFERENCE TO RELATED APPLICATION

This application is based on and claims the benefit of priority to Korean Patent Application No. 10-2014-0179070, filed on Dec. 12, 2014 in the Korean Intellectual Property Office, the disclosure of which is incorporated herein in its entirety by reference.

### TECHNICAL FIELD

The present disclosure relates to a touch screen structure and a manufacturing method thereof, and more particularly, to a touch screen structure and a manufacturing method thereof capable of simultaneously realizing anti-glaring and anti-reflection on the touch screen.

### BACKGROUND

Generally, with the development of electronics & IT industry, a demand for a vehicle having various multimedia functions is growing and application of an audio-video-navi (AVN) integrated module for a vehicle has been expanded. Further, a touch screen has been applied to the AVN to maximize utilization of indoor space and a size of the screen has been gradually increased.

Reflected light of sunlight which is incident on a surface of a display in a vehicle is directed to a driver, and therefore the reflected light obstructs driver's visibility. As a result, dissatisfaction of drivers has been gradually increased. To solve the above problem, a method for improving package and component performance such as a change in a mounting angle and position of a display, an increase in backlight luminance, and application of functional light anti-reflection film has been applied, which may not be a fundamental solution.

As the existing method for preventing external light from being reflected from a display surface, there are an anti-glare coating (AG coating) method and an anti-reflection coating (AR coating) method as illustrated in FIG. 1. The AG coating coats silica or polymer bead on a transparent film to form micro ruggedness on a surface thereof so as to scatter external light and reduce direct reflection, thereby reducing reflected light. However, when the AG coating is excessive, the direct reflection is reduced but haze is increased to cause a turbid phenomenon or reduce sharpness of a display when the AG coating is insufficient, the sharpness is increased but a reverse effect that things reflected due to a mirror effect are projected on the surface of the display may occur. On the other hand, the AR coating alternately coats a material having a high refractive index and a material having a low refractive index on a surface to directly reduce reflected visible light having various wavelength bands of 350 to 750 nm. While simultaneously applying the AG coating and the AR coating is most suitable to reduce the light reflection from the display, it is difficult to thinly form an AR coating layer on an AG coating layer. Moreover, surface visibility may be reduced due to a non-uniform coating thickness. Further, since sufficient adhesion and mechanical strength are hardly secured due to a thin thickness of the AR coating layer, the display is vulnerable to external damages such as scratch and chemical resistance (sweat, cosmetics, cleaner, and the like). Therefore, in the display having a structure like the touch screen, a light reflection reducing structure has been mostly realized by applying the AG coating (film) to the surface (upper surface) and applying the AR coating (film) to a rear (lower surface) of the touch screen.

However, since the light reflection occurs at an interface between media having different refractive indexes, the above structure has a limitation of reducing light reflection which is generated from the AR coating layer which is an upper medium and the AG coating layer which is an uppermost medium.

### SUMMARY

The present disclosure has been made to solve the above-mentioned problems occurring in the prior art while advantages achieved by the prior art are maintained intact.

An aspect of the present disclosure provides a touch screen structure and a manufacturing method thereof capable of simultaneously realizing anti-glaring and anti-reflection on a touch screen.

According to an exemplary embodiment of the present disclosure, a touch screen structure includes a touch panel part preventing light from being reflected to an upper surface and a lower surface; and an LCD part positioned at a lower portion, including the touch panel part and an air layer.

The touch panel part may include: an anti glare film provided on the touch panel to prevent glaring; a first anti reflection coating layer provided on the anti glare film to prevent light reflection; and a second anti reflection coating layer provided beneath the touch panel to prevent the light reflection.

An anti fingerprint coating layer for preventing finger generation may be formed on the first anti reflection coating layer.

According to another exemplary embodiment of the present disclosure, a manufacturing method of a touch screen structure includes alternately depositing Al₂O₃, TiO₂, and SiO₂ on a multilayer; depositing an anti glare film on a touch panel; performing anti reflection coating on a front and a rear of the multilayer; performing argon plasma etching between deposition interfaces; and adding an anti fingerprint coating layer for protecting an anti reflection coating layer and preventing fingerprint pollution on an upper surface of the anti reflection coating layer.

Deposition temperature may be set to be 60° C. to 100° C.

The argon plasma etching may be set to be 30 to 60 seconds.

The anti fingerprint coating layer may be deposited M with fluorocarbon silane.

Al₂O₃ may be first deposited and the anti fingerprint coating layer may be deposited on the top surface.

A deposition coating thickness of the anti fingerprint coating layer may be set to be 200 to 600 nm.

### BRIEF DESCRIPTION OF THE DRAWINGS

The above and other objects, features and advantages of the present disclosure will be more apparent from the following detailed description taken in conjunction with the accompanying drawings;

FIG. 1 is a diagram illustrating a display structure according to the related art; and

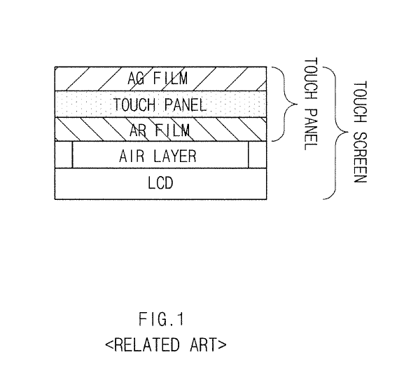

FIG. 2 is a diagram illustrating a display structure according to the exemplary embodiment of the present disclosure.

### DETAILED DESCRIPTION

Exemplary embodiments of the present disclosure will be described in detail with reference to the accompanying drawings.

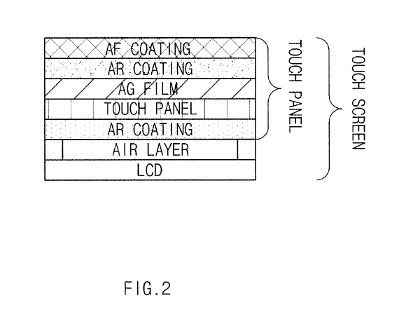

As illustrated in FIG. 2, a touch screen structure according to an exemplary embodiment of the present disclosure includes a touch panel part preventing light reflection and an LCD part positioned beneath the touch panel part, along with an air layer.

The touch panel part prevents light from being reflected to an upper surface and a lower surface.

The touch panel part according to the exemplary embodiment of the present disclosure includes an anti glare (AG) film which is provided on a touch panel to prevent glaring, a first anti reflection (AR) coating layer which is provided on the anti glare film to prevent light reflection, and a second anti reflection coating layer which is provided beneath a touch panel to prevent light reflection.

Further, the touch screen structure according to the exemplary embodiment of the present disclosure is formed by disposing the LCD part at a lower portion, including a touch panel part and an air layer.

In this configuration, an anti fingerprint (AF) coating layer which prevents fingerprint generation may be formed on the first anti reflection coating layer to prevent a fingerprint from being generated on the touch screen.

That is, the exemplary embodiment of the present disclosure has a display structure which may reduce anti reflection of the display to which the touch screen is applied and is a technology of realizing anti reflection and anti fingerprint by depositing an anti reflection coating layer on an anti glare film and an anti fingerprint coating layer thereon.

Further, the exemplary embodiment of the present disclosure has a touch panel structure capable of depositing an anti reflection multilayer thin film on the anti glare film on a lower surface and a top surface of the touch panel to minimize light reflection.

Further, a manufacturing method of a touch screen according to an exemplary embodiment of the present disclosure includes alternately depositing Al₂O₃, TiO₂, and SiO₂ on the multilayer, depositing an anti glare film on the touch panel, performing anti reflection coating on a front and a rear of the multilayer, performing argon plasma etching between deposition interfaces, and adding an anti fingerprint coating layer for protecting an anti reflection coating layer and preventing fingerprint pollution on an upper surface of the anti reflection coating layer.

Further, the exemplary embodiment of the present disclosure uses electron beam-physical vapor deposition (EB-PVD) to manufacture an anti reflection multilayer thin film. A deposition target uses SiO₂ (refractive index of 1.48), Al₂O₃ (refractive index of 1.7), and TiO₂ (refractive index of 2.3) having different refractive indexes and has a structure to minimize light reflection in a wide wavelength band of a visible range by combining a deposition thickness with a structure.

Further, due to characteristics of the touch screen, the touch screen is touched by a user's hand to input a signal. Therefore, Al₂O₃ was deposited as a first layer to reduce deposition surface adsorption of Cl⁻ ions and interface delamination for mechanical durability against sweat, cosmetics, and the like so as to improve salt water resistance and deposition temperature was increased from 60° C. to 100° C. and argon plasma etching was performed for about 30 to 60 seconds to increase adhesion of the deposition layer. Further, fluorocarbon silane is deposited to protect an anti reflection deposition layer and allocate anti-finger print (AF) characteristicse.

Meanwhile, according to the exemplary embodiment of the present disclosure, as described in Table 1, Al₂O₃ is first deposited and the anti fingerprint coating layer is deposited on the top surface.

TABLE 1

| | Deposition Layer (Thickness, A) | | |
|---|---|---|---|
| | | | Example 1 |
| | Comparative | Comparative | of The |
| Order | Example 1 | Example 2 | Disclosure |
| 1 | Al₂O₃ (150) | TiO₂ (150) | Al₂O₃ (150) |
| 2 | TiO₂ (150) | AR | TiO₂ (150) |
| | | (Anti | |
| | | reflection) | |
| | | etching | |
| | | 30 sec | |
| 3 | SiO₂ (378) | SiO₂ (378) | AR |
| | | | (Anti |
| | | | reflection) |
| | | | etching |
| | | | 40 sec |
| 4 | TiO₂ (371) | TiO₂ (371) | SiO₂ (378) |
| 5 | SiO₂ (724) | AR | TiO₂ (371) |
| | | (Anti | |
| | | reflection) | |
| | | etching | |
| | | 30 sec | |
| 6 | TiO₂ (371) | SiO₂ (724) | AR |
| | | | (Anti |
| | | | reflection) |
| | | | etching |
| | | | 40 sec |
| 7 | SiO₂ (724) | Al₂O₃ (100) | SiO₂ (744) |
| 8 | AF | AR | Al₂O₃ (100) |
| | (Anti | (Anti | |
| | fingerprint) | reflection) | |
| | (211) | etching | |
| | | 30 sec | |
| 9 | | SiO₂ (120) | AR |
| | | | (Anti |
| | | | reflection) |
| | | | etching |
| | | | 40 sec |
| 10 | | AF | SiO₂ (60) |
| | | (Anti | |
| | | fingerprint) | |
| | | (255) | |
| 11 | | | AR |
| | | | (Anti |
| | | | reflection) |
| | | | etching |
| | | | 40 sec |
| 12 | | | AF |
| | | | (Anti |
| | | | fingerprint) |
| | | | (267) |
| Total | 3079 | 2353 | 2487 |
| thickness | | | |
| Remarks | Coating layer | Coating layer | No coating layer |
| | lamination by salt | lamination by salt | effect by salt |
| | water/UV | water/UV | water/UV |
| | irradiation | irradiation | irradiation |

In this case, the deposition coating thickness of the anti fingerprint coating is set to be 200 to 600 nm.

As a result, according to the structure in which the anti reflection coating layer and the anti fingerprint coating layer are deposited on the upper surface of the anti glare film and the anti reflection coating is also deposited on the lower surface thereof, as shown in Table 2, light reflectance is more reduced to 0.8% and transmittance is more increased to 94.2% than the related art.

TABLE 2

| | | | Reflec- | | Trans- |
|---|---|---|---|---|---|
| | | | tance | Haze | mittance |
| Comparision | | | (%) | (%) | (%) |
| Comparative | Upper | No surface | 10.1 | 0.0 | 88.1 |
| Example 3 | surface | treatment | | | |
| | Lower | No surface | | | |
| | surface | treatment | | | |
| Comparative | Upper | AG (Anti glare) | 4.2 | 7.4 | 85.4 |
| Example 4 | surface | film | | | |
| | Lower | No surface | | | |
| | surface | treatment | | | |
| Comparative | Upper | AG (Anti glare) | 1.8 | 7.2 | 89.1 |
| Example 5 | surface | film | | | |
| | Lower | AG (Anti glare) | | | |
| | surface | film | | | |
| Example 2 | Upper | AG (Anti glare) | 0.8 | 5.6 | 94.2 |
| of The | surface | film + Example 1 | | | |
| Disclosure | | of The Disclosure | | | |
| | | (AR + AF | | | |
| | | deposition) | | | |
| | Lower | Example 1 of The | | | |
| | surface | Disclosure (AR | | | |
| | | deposition) | | | |

In this case, in Comparative Example 3, the haze of a sample in which no treatment is performed on the upper and lower surfaces of the touch panel is 0 but light reflectance is very high as 10.1% due to the direct reflection, in Comparative Example 4, the haze of a sample in which the AG film treatment is performed only on the upper surface of the touch panel is 7.4% and the reflectance is 4.2% but the transmittance is very low, and in Comparative Example 5, a structure in which the AG film is applied to the upper surface of the touch panel and the AR film is applied to the lower surface thereof is most applied as the light reflection reducing structure of the general touch screen and the reflectance is low as 1.8%.

However, Example 2 of the Disclosure has a structure in which the AR (anti reflection) film/AF (anti fingerprint) film are deposited on the upper surface of the AG (anti glare) film and the AR (anti reflection) film is also deposited on the lower surface thereof and the light reflectance is very low as 0.8% and the transmittance highest appears as 94.2%.

Further, as shown in Table 3, the reflectance of the touch screen is reduced to 1.3% and a light reflection luminance value based on regular reflection also appears as a low value as much as 13,000 nit.

TABLE 3

| | | | Light reflection | |
|---|---|---|---|---|
| | | Reflec- | luminance | White color |
| | Touch panel | tance | (based on | luminance |
| Comparison | structure | (%) | 45° C., nit) | (nit) |
| Comparative | Comparative | 10.5 | 65,780 | 408 |
| Example 6 | Example 3 | | | |
| Comparative | Comparative | 4.4 | 29,830 | 426 |
| Example 7 | Example 4 | | | |
| Comparative | Comparative | 1.9 | 19,560 | 462 |
| Example 8 | Example 5 | | | |
| Example 3 | Example 2 | 1.3 | 13,000 | 472 |
| of The | of The | | | |
| Disclosure | Disclosure | | | |

In this case, in Comparative Example 6, when no M treatment touch panel is applied, considering the characteristics of the touch panel in which the reflectance and light reflection luminance based on the regular reflection of the touch screen are very high and the transmittance is low, the luminance of white color represented by the touch screen is low but in Example 3 of the Disclosure, the reflectance of the touch screen is lowest as 1.3% and the light reflection luminance value based on the regular reflection appears as the lowest value as much as 13,000 nit.

Further, like Example 2, the transmittance is increased and therefore the luminance value of the white color represented by the touch screen is increased, thereby reducing the light reflection and increasing the sharpness of the display.

As such, the present disclosure deposits the anti glare film on the upper and lower surfaces to save costs as much as about 10% as compared with the related art and additionally deposits fluorocarbon silane on the anti fingerprint layer to protect the anti glare deposition layer and allocate the anti fingerprint characteristics, thereby improving the durability and the anti fingerprint characteristics.

Further, the anti reflection layer is not formed on the top surface in the existing anti reflection film structure, but the anti reflection deposition coating is instead applied and thus 1.9% of the light reflectance of the existing touch screen is reduced to 1.3%.

Further, as a result of assessing visibility sensibility under daytime sunlight of the display of the touch screen to which the technology of the present disclosure is applied, a JURY assessment stage may be improved as much as 2 stages and the light reflection reducing coating structure of the present disclosure may be applied to a touch screen AVN system for a vehicle, a surface of a display of various kinds of display devices, and electronics & IT industry.

As described above, according to the exemplary embodiments of the present disclosure, the high-durability anti reflection coating layer is formed on the anti glare film to improve the scratch resistance, the salt water resistance, the light resistance, and the like so as to reduce the light reflectance of the touch screen and improve the visibility, thereby improving the marketability and convenience and realizing the anti-glaring to safely drive the vehicle.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A touch screen structure, comprising:
an LCD part positioned at a lower portion, including a touch panel part and an air layer, the touch panel part preventing light from being reflected to an upper surface and a lower surface thereof.

2. The touch screen structure according to claim 1, wherein the touch panel part includes:
an anti glare film provided on a touch panel to prevent glaring;
a first anti reflection coating layer disposed on the anti glare film to prevent light reflection; and
a second anti reflection coating layer disposed beneath the touch panel to prevent the light reflection.

3. The touch screen structure according to claim 2, wherein an anti fingerprint coating layer for preventing finger generation is formed on the first anti reflection coating layer.

4. A method of manufacturing a touch screen structure, the method comprising:
alternately depositing Al₂O₃, TiO₂, and SiO₂ on a multilayer;
depositing an anti glare film on a touch panel;
performing anti reflection coating on a front and a rear of the multilayer;
performing argon plasma etching between deposition interfaces; and
adding an anti fingerprint coating layer for protecting an anti reflection coating layer and preventing fingerprint pollution on an upper surface of the anti reflection coating layer.

5. The method according to claim 4, wherein deposition temperature is set to be 60° C. to 100° C.

6. The method according to claim 4, wherein the argon plasma etching is done for 30 to 60 seconds.

7. The method according to claim 4, wherein the anti fingerprint coating layer is deposited with fluorocarbon silane.

8. The method according to claim 4, wherein Al₂O₃ is first deposited and the anti fingerprint coating layer is deposited on a top surface of the anti reflection coating layer.

9. The manufacturing method according to claim 4, wherein a deposition coating thickness of the anti fingerprint coating layer is set to be 200 to 600 nm.
